(19) United States
(12) Patent Application Publication
(10) Pub. No.: US 2026/0025850 A1
(43) Pub. Date: Jan. 22, 2026

(54) METHOD, APPARATUS, TERMINAL, AND MEDIUM FOR PROCESSING SIDELINK CONSISTENT LISTEN BEFORE TALK FAILURE

(71) Applicant: VIVO MOBILE COMMUNICATION CO., LTD., Dongguan (CN)

(72) Inventors: Jianhui LI, Dongguan (CN); Xiao XIAO, Dongguan (CN)

(73) Assignee: VIVO MOBILE COMMUNICATION CO., LTD., Dongguan (CN)

(21) Appl. No.: 19/342,462

(22) Filed: Sep. 26, 2025

Related U.S. Application Data
(63) Continuation of application No. PCT/CN2024/085632, filed on Apr. 2, 2024.

(30) Foreign Application Priority Data
Apr. 6, 2023 (CN) 202310370357.8

(51) Int. Cl. H04W 74/0808; H04L 5/00; H04W 76/40

(52) U.S. Cl. CPC H04W 74/0808; H04L 5/0098; H04W 76/40

(57) ABSTRACT

A method, an apparatus, a terminal, and a medium for processing a sidelink consistent listen before talk failure, are provided. The method for processing a sidelink consistent listen before talk (LBT) failure includes: determining, by a terminal, that the sidelink consistent LBT failure is triggered on a first resource; and performing, by the terminal, a first operation, where the first operation includes at least one of the following: resource selection or resource reselection or resource switching; determining that the first resource is recovered from the sidelink consistent LBT failure, or canceling the sidelink consistent LBT failure triggered on the first resource; and a Media Access Control (MAC) layer of the terminal informs a PHYsical (PHY) layer: the first resource is recovered from the sidelink consistent LBT failure, or canceling the sidelink consistent LBT failure triggered on the first resource.

### CROSS-REFERENCE TO RELATED APPLICATIONS

This application is a continuation of International Application No. PCT/CN2024/085632, filed Apr. 2, 2024, which claims priority to Chinese Patent Application No. 202310370357.8, filed Apr. 6, 2023. The entire contents of each of the above-referenced applications are expressly incorporated herein by reference.

### TECHNICAL FIELD

This application belongs to the field of communication technologies, and in particular, to a method, an apparatus, a terminal, and a medium for processing a sidelink consistent listen before talk failure.

### BACKGROUND

When a terminal performs sidelink transmission in an unlicensed band, a sidelink consistent Listen Before Talk (LBT) failure may occur.

However, the related technology does not provide an effective consistent LBT failure processing procedure for a SideLink-Unlicense (SL-U) system, which makes it difficult for the terminal to process the consistent LBT failure when performing sidelink transmission in the unlicensed band.

### SUMMARY

Embodiments of this application provide a method, an apparatus, a terminal, and a medium for processing a sidelink consistent listen before talk failure.

According to a first aspect, a method for processing a sidelink consistent listen before talk failure is provided, where the method includes:
determining, by a terminal, that the sidelink consistent listen before talk (LBT) failure is triggered on a first resource; and
performing, by the terminal, a first operation, where the first operation includes at least one of the following:
resource selection or resource reselection or resource switching;
determining that the first resource is recovered from the sidelink consistent LBT failure, or canceling the sidelink consistent LBT failure triggered on the first resource; and
a media access control (MAC) layer of the terminal informs a physical (PHY) layer: the first resource is recovered from the sidelink consistent LBT failure, or canceling the sidelink consistent LBT failure triggered on the first resource.

According to a second aspect, an apparatus for processing a sidelink consistent listen before talk failure is provided, where the apparatus includes:
a first processing module, configured to determine that the sidelink consistent listen before talk (LBT) failure is triggered on a first resource; and
a first execution module, configured to perform a first operation, where the first operation includes at least one of the following:
resource selection or resource reselection or resource switching;
determining that the first resource is recovered from the sidelink consistent LBT failure, or canceling the sidelink consistent LBT failure triggered on the first resource; and
a media access control (MAC) layer of the terminal informs a physical (PHY) layer: the first resource is recovered from the sidelink consistent LBT failure, or canceling the sidelink consistent LBT failure triggered on the first resource.

According to a third aspect, a terminal is provided. The terminal includes a processor and a memory, the memory stores a program or an instruction that can be run on the processor, and when the program or the instruction is executed by the processor, the steps of the method for processing a sidelink consistent listen before talk failure according to the first aspect are implemented.

According to a fourth aspect, a readable storage medium is provided, the readable storage medium stores a program or an instruction, and when the program or the instruction is executed by a processor, the steps of the method for processing a sidelink consistent listen before talk failure according to the first aspect are implemented.

According to a fifth aspect, a chip is provided, where the chip includes a processor and a communication interface, the communication interface is coupled to the processor, and the processor is configured to run a program or an instruction to implement the method for processing a sidelink consistent listen before talk failure according to the first aspect.

According to a sixth aspect, a computer program/program product is provided, where the computer program/program product is stored in a storage medium, and the program/program product is executed by at least one processor to implement the steps of the method for processing a sidelink consistent listen before talk failure according to the first aspect.

### BRIEF DESCRIPTION OF DRAWINGS

FIG. 1 is a block diagram of a wireless communication system to which the embodiments of this application are applicable;

FIG. 2 is a schematic diagram of link transmission according to an embodiment of this application;

FIG. 3 is a schematic diagram of a sidelink transmission resource according to an embodiment of this application;

FIG. 4 is a flowchart of a method for processing a sidelink consistent listen before talk failure according to an embodiment of this application;

FIG. 5 is a structural block diagram of an apparatus for processing a sidelink consistent listen before talk failure according to an embodiment of this application;

FIG. 6 is a structural block diagram of a communication device according to an embodiment of this application; and

FIG. 7 is a schematic diagram of a hardware structure of a terminal according to an embodiment of this application.

### DETAILED DESCRIPTION

The following describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

Terms such as “first” and “second” in this application are used to distinguish between similar objects, and are not used to describe a specific order or sequence. It should be understood that, the terms used in such a way are interchangeable in proper circumstances, so that the embodiments of this application can be implemented in an order other than the order illustrated or described herein. Objects classified by “first” and “second” are usually of a same type, and a quantity of objects is not limited. For example, there may be one or more first objects. In addition, in this application, “or” indicates at least one of connected objects. For example, “A or B” covers three solutions, namely, solution 1: including A and not including B; solution 2: including B and not including A; and solution 3: including A and B. A character “/” generally indicates an “or” relationship between the associated objects.

The term “indication” in this application may be either a direct indication (or referred to as an explicit indication) or an indirect indication (or referred to as an implicit indication). The direct indication can be understood as that a sender clearly informs a receiver of specific information, an operation required to be performed, a request result, or the like in a sent indication; and the indirect indication can be understood as that the receiver determines corresponding information based on an indication sent by the sender, or makes a determination and determines the operation required to be performed, the request result, or the like based on a determination result.

It should be noted that technologies described in the embodiments of this application are not limited to a Long Term Evolution (LTE)/LTE-Advanced (LTE-A) system, and may be further applied to other wireless communication systems such as Code Division Multiple Access (CDMA), Time Division Multiple Access (TDMA), Frequency Division Multiple Access (FDMA), Orthogonal Frequency Division Multiple Access (OFDMA), or Single-carrier Frequency-Division Multiple Access (SC-FDMA). The terms “system” and “network” in the embodiments of this application may be used interchangeably. The technologies described can be applied to both the systems and the radio technologies mentioned above as well as to other systems and radio technologies. The following descriptions describe a New Radio (NR) system for example purposes, and NR terms are in most of the following descriptions, but these technologies can also be applied to a system other than the NR system, for example, a 6^{th} Generation (6G) communication system.

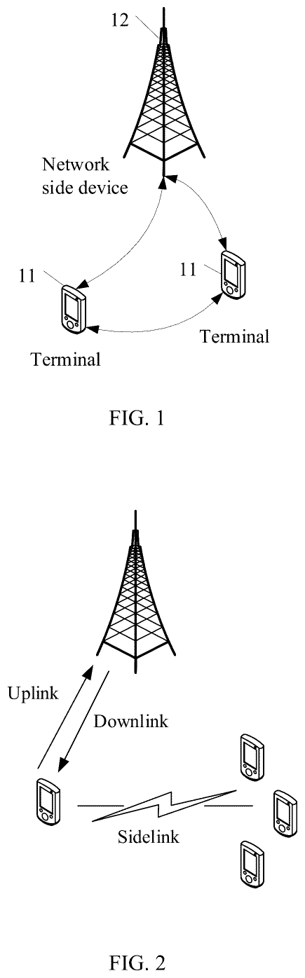

FIG. 1 is a block diagram of a wireless communication system to which the embodiments of this application may be applied. The wireless communication system includes a terminal 11 and a network side device 12. The terminal 11 may be a terminal side device such as a mobile phone, a tablet personal computer, a laptop computer, a notebook computer, a Personal Digital Assistant (PDA), a palmtop computer, a netbook, an Ultra-Mobile Personal Computer (UMPC), a Mobile Internet Device (MID), an Augmented Reality (AR) or Virtual Reality (VR) device, a robot, a wearable device, a flight vehicle, Vehicle User Equipment (VUE), ship-borne equipment, Pedestrian User Equipment (PUE), smart household (household devices with wireless communication functions, such as a refrigerator, a television, a washing machine, or furniture), a game console, a personal computer, a teller machine, or a self-service machine. The wearable device includes: a smart watch, a smart band, a smart headset, smart glasses, smart jewelry (a smart bracelet, a smart hand chain, a smart ring, a smart necklace, a smart bangle, a smart anklet, and the like), a smart wristband, smart clothing, and the like. The vehicle user equipment may also be referred to as a vehicle-mounted terminal, a vehicle-mounted controller, a vehicle-mounted module, a vehicle-mounted component, a vehicle-mounted chip, a vehicle-mounted unit, or the like. It should be noted that a specific type of the terminal 11 is not limited in the embodiments of this application. The network side device 12 may include an Access Network Device or a core network device. The access network device may also be referred to as a Radio Access Network (RAN) device, a radio access network function, or a radio access network unit. The access network device may include a base station, a Wireless Local Area Network (WLAN) Access Point (AP), a Wireless Fidelity (Wi-Fi) node, and the like. The base station may be referred to as a NodeB (NB), an evolved NodeB (eNB), a next generation NodeB (gNB), a New Radio NodeB (NR NodeB), an access point, a Relay Base Station (RBS), a Serving Base Station (SBS), a Base Transceiver Station (BTS), a radio base station, a radio transceiver, a Basic Service Set (BSS), an Extended Service Set (ESS), a Home NodeB (HNB), a Home evolved NodeB (HeNB), a Transmission Reception Point (TRP), or another appropriate term in the field. As long as a same technical effect is achieved, the base station is not limited to a specified technical term. It should be noted that, in the embodiments of this application, only a base station in an NR system is used as an example for description, but a specific type of the base station is not limited.

To facilitate understanding of the technical solutions provided in this application, main technical concepts involved in the embodiments of this application are briefly described below.

### Introduction to the Concept of Sidelink

As shown in FIG. 2, SideLink (SL, also referred to as a secondary link, a side link, an edge link, or the like) transmission is direct data transmission between User Equipments (UEs) on a physical layer. An LTE SideLink performs communication via broadcasting. Although being applicable to supporting basic safety-related communication of vehicle to everything (V2X), the LTE SideLink is inapplicable to other V2X services of a higher level. A 5G NR system supports more advanced designs of SideLink transmission, such as unicast, broadcast, groupcast, or the like, thereby supporting services of more comprehensive types.

An R16 NR SideLink may include the following channels:
a Physical Sidelink Control CHannel (PSCCH);
a Physical Sidelink Shared CHannel (PSSCH);
a Physical Sidelink Broadcast CHannel (PSBCH); and
a Physical Sidelink Feedback CHannel (PSFCH).

### Sidelink Resource Structure

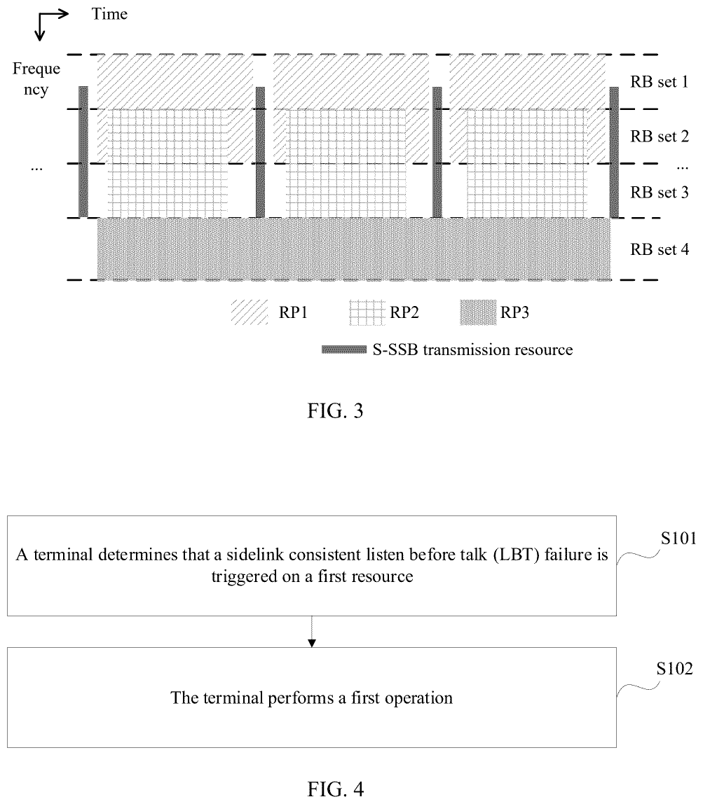

Because of working in an unlicensed band, both a design of a New Radio-Unlicense (NR-U) system and a design of an SL-U system support a resource structure based on “sub-band”. The “sub-band” (Sub-band) refers to a part of an entire bandwidth corresponding to a carrier in the unlicensed band. In the NR-U and the SL-U, one Sub-band is referred to as a “Resource Block set (RB set)”, which corresponds to a set of “time-frequency” resources. Particularly, as shown in FIG. 3, for the SL-U, one resource pool (Resource Pool, RP) may include one or more RB sets (corresponding resources).

For the SL-U, the current 3rd Generation Partnership Project (3GPP) standard agrees that one SL-U carrier includes only one BandWidth Part (BWP). Further, one BWP may include one or more resource pools, and one resource pool may include one or more RB sets.

The current 3GPP standard agrees that a resource granularity of a SideLink Listen Before Talk failure (SL LBT failure) indicated by a PHYsical (PHY) layer to a Media Access Control (MAC) layer is the RB set. Therefore, the following description of processing and recovery of a SideLink consistent Listen Before Talk failure (SL consistent LBT failure) is mainly based on the resource granularity of Resource Pool and RB set levels, but the processing scheme of the sidelink consistent listen before talk failure provided in the embodiments of this application is also applicable to other resource granularity levels such as carrier and BWP.

### Introduction to the Concept of Listen Before Talk

In a future communication system, an unlicensed band (unlicensed band) may be used as a supplement to a licensed band (licensed band) to help an operator expand a service. To be consistent with NR deployment and maximize an NR-based unlicensed access as much as possible, the unlicensed band may work in bands of 5 GHz, 37 GHz, and 60 GHz. A large bandwidth (80 or 100 MHz) of the unlicensed band can reduce implementation complexity of a base station and UE. The unlicensed band is shared by a plurality of Radio Access Technologies (RATs), such as Wi-Fi, radar, and Long Term Evolution-License Assisted Access (LTE-LAA). Therefore, in some countries or regions, the unlicensed band must comply with regulations such as LBT and a Maximum Channel Occupancy Time (MCOT) when being used, to ensure that all devices can use the resource fairly.

For example, when a transmission node needs to send information, LBT needs to be performed first for Energy Detection (ED) on surrounding nodes. When detected energy is lower than a threshold, it is considered that a channel is idle (idle), and the transmission node can send the information. Otherwise (when the detected energy is not lower than the threshold), it is considered that the channel is busy, and the transmission node cannot send the information. The transmission node may be a base station, UE, a Wi-Fi Access Point (AP), or the like. After the transmission node starts to transmit, a Channel Occupancy Time (COT) cannot exceed the MCOT. In addition, according to the Occupied Channel Bandwidth regulation (OCB regulation), in the unlicensed band, the transmission node occupies at least 70% (60 GHz) or 80% (5 GHz) of the bandwidth of the entire band at each transmission.

Types (type) of LBT commonly used in the NR-U may be classified as Type1, Type2A, Type2B, and Type2C. Type1 LBT is a channel sense mechanism based on back-off (back-off). When a transmission node senses that the channel is busy, back-off is performed, and sensing is performed continuously until it is sensed that the channel is idle. Type2C indicates that the sending node does not perform LBT (that is, no LBT) or performs immediate transmission (immediate transmission). Type2ALBT and Type2B LBT belong to one-shot LBT, that is, the node performs LBT once before transmission, transmission is performed when the channel is idle, and transmission is not performed when the channel is busy. The difference is that for Type2A, LBT is performed in 25 μs, which is applicable to a gap between two transmissions greater than or equal to 25 μs when a COT is shared. However, for Type2B, LBT is performed in 16 μs, which is applicable to a gap between two transmissions equal to 16 μs when a COT is shared.

In addition, there is also Type2 LBT, which is applicable to License Assisted Access (LAA)/enhanced LAA (eLAA)/Further enhanced LAA (FeLAA). When the COT is shared, and the gap between two transmissions is greater than or equal to 25 μs, the Evolved NodeB (eNB) and the UE may adopt Type2 LBT. In a frequency range 2-2, types of LBT are Type1, Type2, and Type3. Type1 is a channel sense mechanism based on back-off; Type2 is one-shot LBT, and the LBT performing 5 μs in 8 μs; and Type3 performs no LBT.

### LBT Failure Detection and Consistent LBT Failure Detection/Processing

The NR-U supports an RB set structure of the unlicensed band, and an LBT operation of the NR-U is performed independently on each RB set. On each cell (namely, one carrier) of the NR-U, the network side device may configure one or more BWPs for the UE, each BWP may include some frequency domain resources in the bandwidth of the cell, and each BWP may include one or more RB sets. In addition, the network side device may activate one BWP for the UE, and schedule UpLink (UL) and DownLink (DL) communication resources for the UE on the activated BWP, and the UE is allowed to use only resources of the currently activated BWP for communication on this cell.

In view of this, for each UL transmission of the UE, because one BWP may include one or more RB sets in frequency domain, UL transmission resources thereof may include resources on one or more RB sets. For this UL transmission, the UE may separately perform the LBT operation on all involved RB sets, and if the LBT failure occurs on “any” RB set (that is, it is difficult to access), the UE considers that the LBT failure is detected for this UL transmission, and the UL transmission cannot be performed.

Due to resource competition among terminals of other Radio Access Technologies (RATs) such as Wi-Fi in the unlicensed band, UE may consistently detect the LBT failure. This means that the channel is busy at present and normal communication may not be performed. Therefore, the NR-U supports “consistent LBT failure” detection and a related processing mechanism of the UE, and it is determined whether to trigger the “consistent LBT failure” process by recording a cumulative number of LBT failures that occur on the currently activated BWP in each cell. Specifically, the PHY layer of the UE may perform the LBT operation for each UL transmission, and when the LBT failure is detected for a UL transmission, it is indicated to the MAC layer that the LBT failure is detected for this UL transmission (namely, “LBT failure indication”). Because the physical layer may not inform the MAC layer of a specific RB set in which the LBT failure occurs, the MAC layer considers that one LBT failure is detected in a BWP in which the current UL transmission is performed (that is, the current activated BWP), and cumulatively counts the number of detected LBT failures.

When the number of cumulative counts of LBT failures for any UL transmission detected by the UE reaches a threshold configured by the network side device, the UE triggers the consistent LBT failure. After triggering the consistent LBT failure, the UE may stop communication in the corresponding cell and BWP, may report it to the network side device, and wait for the network side device to recover for the consistent LBT failure (such as resource reconfiguration and the like). After reporting the consistent LBT failure to the network side device, the UE may cancel the reported consistent LBT failure of the cell.

### Channel Access Priority Class (CAPC)

eNB/gNB/UE needs to determine a CAPC value before occupying a channel, to look up the table to determine a window parameter of channel access for LBT. As shown in Table 1 below, the value of CAPC is p=1 to 4, where p=1 represents a highest priority, and a corresponding LBT window is shorter than those of other priorities, but an MCOT length is also correspondingly shorter, which reflects fairness of different devices to occupy the channel to some extent.

For p=3 and p=4, if it can be guaranteed that no other RATs share this channel in the long term (such as restricted by laws and regulations), corresponding maximum channel occupancy times are 10 ms or 8 ms.

TABLE 1

| Channel | | Minimum | Maximum | Maximum | | |
|---|---|---|---|---|---|---|
| access | | contention | contention | channel | | Allowed |
| priority | Delay | window | window | occupancy | | contention |
| class | Parameter | (CWmin, | (CWmax, | time | | window |
| (p) | (mp) | p) | p) | (Tmcot, p) | | size |
| 1 | 1 | 3 | 7 | 2 | ms | {3, 7} |
| 2 | 1 | 7 | 15 | 3 | ms | {7, 15} |
| 3 | 3 | 15 | 63 | 8 or 10 | ms | {15, 31, 63} |
| 4 | 7 | 15 | 1023 | 8 or 10 | ms | {15, 31, 63, |
| | | | | | | 127, 255, |
| | | | | | | 511, 1023} |

When the UE performs LBT to send uplink data, a CAPC value of this LBT needs to be determined based on a type of to-be-sent data in a protocol agreement or network configuration manner. When the data to be sent by the UE includes data carried by three signaling resource bearers: SRB0/SRB1/SRB3, p=1 is always used by default. For signaling resource bearer SRB2/data resource bearer DRB, the network side device may configure a CAPC value for the UE to send data carried by SRB2 and DRB.

### UE Measurement

UE may measure a channel occupancy situation by measuring a Channel Occupancy (CO) or a Constant Bit Rate (CBR) of a carrier. The CO is a measurement quantity at a carrier level, which is used for UE to estimate the channel occupancy within the carrier, and the CBR is a measurement quantity at a resource pool level, which is used for SL UE to estimate the channel occupancy in the resource pool.

For the SL-U, the principle discussed in the current 3GPP standard is to reuse the existing NR-U process to the greatest extent. However, a basic difference between the SL-U and the NR-U is that transmission resources of SL transmission have a resource pool-level resource granularity between the RB set and the BWP. Therefore, when the PHY layer detects the SL LBT failure and indicates the SL LBT failure to the MAC layer, the UE is no longer suitable for cumulative count of LBT failures and determination of consistent LBT failures in a manner of per cell (per cell) in the NR-U. At present, the 3GPP standard has agreed that the SL-U introduces LBT failure detection by using the RB set as the resource granularity, which requires additional design performed by the SL-U to support consistent LBT failure detection and processing for the SL-U.

For the problem in the related art, this application provides a method for processing a sidelink consistent listen before talk failure, which can process the triggered sidelink consistent listen before talk failure, and can improve a success rate of channel access.

With reference to the accompanying drawings, the following describes in detail the method, the apparatus, the terminal, and the medium for processing a sidelink consistent listen before talk failure provided in the embodiments of this application by using some embodiments and application scenarios thereof.

According to a first aspect, FIG. 4 is a flowchart of a method for processing a sidelink consistent listen before talk failure according to an embodiment of this application, and the method may include the following steps.

Step S101: A terminal determines that the sidelink consistent listen before talk (LBT) failure is triggered on a first resource.

The first resource is a first resource of a first resource granularity. If the terminal determines that the sidelink consistent LBT failure is triggered on at least one resource or all resources of a third resource granularity in the first resource, the terminal determines that the sidelink consistent LBT failure is triggered on the first resource (such as a resource pool), and the first resource granularity is greater than the third resource granularity. For example, if the resource pool of the terminal includes a plurality of RB sets, if the terminal determines that at least one RB set in the resource pool triggers the LBT failure, the terminal determines that the LBT failure is triggered on the resource pool.

During specific implementation, the terminal may perform an LBT operation on the first resource involved in SL transmission. If the LBT failure (that is, it is difficult to access) occurs on the first resource (or a resource in the first resource), the terminal determines that the sidelink LBT failure is triggered on the first resource.

In some implementations, the terminal cumulatively counts the sidelink LBT failures triggered on the first resource, and when the cumulative count of the sidelink LBT failures triggered on the first resource reaches the threshold configured by the network, the terminal determines that the sidelink consistent LBT failure is triggered on the first resource, thereby realizing consistent LBT failure detection for SL transmission.

As an implementation, the PHY layer of the terminal is responsible for performing the LBT operation on the first resource involved in SL transmission, and indicating, to the MAC layer of the terminal, that the sidelink LBT failure is triggered on the first resource. The MAC layer of the terminal is responsible for cumulatively counting the sidelink LBT failures triggered on the first resource and determining whether the sidelink consistent LBT failure is triggered on the first resource.

Step S102: The terminal performs a first operation.

The first operation includes at least one of the following:
resource selection or resource reselection or resource switching;
determining that the first resource is recovered from the sidelink consistent LBT failure, or canceling the sidelink consistent LBT failure triggered on the first resource; and
a Media Access Control (MAC) layer of the terminal informs a PHYsical (PHY) layer: the first resource is recovered from the sidelink consistent LBT failure, or canceling the sidelink consistent LBT failure triggered on the first resource.

During specific implementation, when the terminal determines that the sidelink consistent LBT failure is triggered on the first resource, it indicates that the first resource is difficult to access in the current period of time, and it is difficult for the terminal to perform SL transmission on the first resource. In this case, the terminal may select/reselect/switch to other resources to resume SL transmission. After a channel access success rate of the first resource is improved (for example, the terminal waits for a period of time and detects that a resource occupancy is reduced), the terminal may determine that the first resource is recovered from the sidelink consistent LBT failure, or the MAC layer of the terminal informs the PHY layer: the first resource is recovered from the sidelink consistent LBT failure. When the first resource is recovered from the sidelink consistent LBT failure, or the terminal performs resource selection or resource reselection or resource switching, or the MAC layer of the terminal is reset, or the like, which enables the terminal to no longer care about the first resource, the terminal may cancel the sidelink consistent LBT failure triggered on the first resource, or the MAC layer of the terminal informs the PHY layer: cancel the sidelink consistent LBT failure triggered on the first resource. In this way, the sidelink consistent LBT failure is processed.

It can be learned from the foregoing steps, when the terminal triggers the sidelink consistent LBT failure on the first resource, at least one relevant first operation, such as resource selection or resource reselection or resource switching, recovering the first resource from the sidelink consistent LBT failure, and canceling the sidelink consistent LBT failure may be performed to process the consistent LBT failure triggered when the terminal performs sidelink transmission.

### Implementation 1

This implementation describes an example of conditions under which the terminal triggers behaviors of resource selection or resource reselection or resource switching.

The terminal performs resource selection or resource reselection or resource switching in a case that a second resource of the second resource granularity to which the first resource belongs meets at least one of the following conditions:
there are at least M resources that are of the first resource granularity and on which the sidelink consistent LBT failure is triggered and is not canceled yet in the second resource, where M is a value not less than 0. For example, in a case that there are at least M RB sets on which the sidelink consistent LBT failure is triggered and is not canceled yet in a resource pool, or there are at least M resource pools on which the sidelink consistent LBT failure is triggered and is not canceled yet in a carrier/BWP, it indicates that a channel access success rate of the resource pool or the carrier/BWP is low in the current period of time. Therefore, the terminal may perform resource selection or resource reselection or resource switching operation for the second resource (such as the resource pool or the carrier), to select/reselect/switch to a new second resource with a higher channel access success rate, thereby realizing SL transmission by using a resource of the first resource granularity (such as the RB set or the resource pool) in the new second resource;
a proportion of resources that are of the first resource granularity and on which the sidelink consistent LBT failure is triggered and is not canceled yet in the second resource is not less than N %, and N is a value that is not less than 0 and not greater than 100. For example, when a proportion of a quantity of the resources that are of the first resource granularity and on which the sidelink consistent LBT failure is triggered and is not canceled yet in the second resource to a total quantity of resources of the first resource granularity in the second resource is not less than N %, it indicates that there are many resources of the first resource granularity in the second resource that are difficult to access in the current period of time. Therefore, the terminal may perform resource selection or resource reselection or resource switching operation, to select/reselect/switch to a resource with a higher channel access success rate, thereby realizing SL transmission; and
the sidelink consistent LBT failure is triggered and is not canceled yet on all resources of the first resource granularity in the second resource. For example, when the sidelink consistent LBT failure is triggered and is not canceled yet on all RB sets in a resource pool, it indicates that the resource pool is difficult to access. Therefore, the terminal may perform resource selection or resource reselection or resource switching operation, to select/reselect/switch to another resource for resuming SL transmission.

The first resource is a first resource of the first resource granularity, and the second resource granularity is greater than the first resource granularity. The parameters M and N may be configured by a network, predefined by a protocol, or determined through negotiation between UEs.

### Implementation 2

This implementation describes an example of requirements of a target resource of the second resource granularity selected/reselected/switched by the terminal.

To improve the channel access success rate during SL transmission, the target resource of the second resource granularity selected or reselected or switched by the terminal in performing the first operation may meet at least one of the following conditions:
there are at least P resources that are of the first resource granularity and on which the sidelink consistent LBT failure is not triggered in the target resource of the second resource granularity, and P is a value not less than 0;
a proportion of resources that are of the first resource granularity and on which the sidelink consistent LBT failure is not triggered in the target resource of the second resource granularity is not less than Q %, and Q is a value that is not less than 0 and not greater than 100; and
there is at least one resource that is of the first resource granularity and on which the sidelink consistent LBT failure is not triggered in the target resource of the second resource granularity.

The parameters P and Q may be configured by a network, predefined by a protocol, or determined through negotiation between UEs.

In this embodiment, the terminal performs the LBT operation for the first resource of the first resource granularity involved in SL transmission. If there are at least P resources that are of the first resource granularity and on which the sidelink consistent LBT failure is not triggered in the target resource of the second resource granularity, or a proportion of a quantity of resources that are of the first resource granularity and on which the sidelink consistent LBT failure is not triggered in the target resource of the second resource granularity to a total quantity of all resources of the first resource granularity in the target resource of the second resource granularity is not less than Q %, or there is at least one resource that is of the first resource granularity and on which the sidelink consistent LBT failure is not triggered in the target resource of the second resource granularity, it indicates that there are many resources or there exists a resource of the first resource granularity available in the target resource in the current period of time. Therefore, the terminal selects/reselects/switches to the target resource that meets the foregoing conditions, to improve the channel access success rate during SL transmission.

It can be understood that, in combination with Implementation 1 or Implementation 2, when performing resource selection or resource reselection or resource switching at the second resource granularity, the terminal is easier to select or reselect or switch to a target resource with higher channel access success rate, which may improve effectiveness of resource selection. The second resource granularity is greater than the first resource granularity, and the performing, by the terminal, resource selection or resource reselection or resource switching at a second resource granularity may include at least one of the following:
in a case that the first resource is a first RB set, performing, by the terminal, resource pool (resource pool) selection/reselection/switching;
in a case that the first resource is a first sub-channel (sub-channel), performing, by the terminal, RB set selection/reselection/switching;
in a case that the first resource is a first resource pool, performing, by the terminal, BWP selection/reselection/switching; and
in a case that the first resource is a first BWP, performing, by the terminal, carrier selection/reselection/switching.

### Implementation 3

This implementation describes an example of how the terminal determines the selected/reselected/switched target resource from candidate resources.

After determining that the sidelink consistent LBT failure is triggered on the first resource of the first resource granularity, the terminal may determine respective priorities of the candidate resources of the second resource granularity, and select/reselect/switch the target resource of the second resource granularity based on the respective priorities of the candidate resources of the second resource granularity. Based on different information used to determine the priority of the candidate resource, there are three cases as follows.

Case 1: Determine the respective priorities of the candidate resources of the second resource granularity based on respective types of the candidate resources of the second resource granularity.

The priorities corresponding to different resource types may be configured by a network, predefined by a protocol, or determined through negotiation between UEs.

In this embodiment, the terminal can prioritize a candidate resource of a high-priority resource type as the target resources for selection/reselection/switching, to find a more proper resource for SL transmission for current data to be transmitted.

In an example in which the second resource granularity is a resource pool, types of candidate resource pools may include at least one of the following: a normal resource pool type; and a special resource pool type.

Resource pools of the normal resource pool type may include a discovery resource pool (discovery resource pool), a communication resource pool (communication resource pool), and the like. Resource pools of the special resource pool type are mainly used to temporarily select resources for SL transmission when special events occur. Therefore, a priority of the normal resource pool type may be configured (or predefined or determined through negotiation) to be higher than that of the special resource pool type, so that the terminal can use a resource pool of the normal resource pool type for SL transmission more often when the special events do not occur.

Case 2: Determine the respective priorities of the candidate resources of the second resource granularity based on a quantity or a proportion of resources that are of the first resource granularity and on which the sidelink consistent LBT failure is not triggered in each candidate resource of the second resource granularity.

In this embodiment, the terminal can prioritize a candidate resource with less channel occupancy as the target resources for selection/reselection/switching, to find a resource with a higher channel access success rate for SL transmission for current data to be transmitted.

As an implementation, the terminal may comprehensively determine the priority of the candidate resource in combination with Case 1 and Case 2. In this case, the priorities of the candidate resources of the second resource granularity may successively decrease in the following order:
the quantity or the proportion of the resources that are of the first resource granularity and on which the sidelink consistent LBT failure is not triggered in the candidate resource of the second resource granularity is not less than a first threshold;
the quantity or the proportion of the resources that are of the first resource granularity and on which the sidelink consistent LBT failure is not triggered in the candidate resource of the second resource granularity is less than the first threshold; and
the type of the candidate resource of the second resource granularity is a target type.

An example in which the terminal selects/reselects/switches a resource pool is used. The terminal may preferentially select/reselect/switch a resource pool of the normal resource pool type having at least PRB sets on which the sidelink consistent LBT failure is not triggered in the resource pool (or a proportion of a quantity of RB sets on which the sidelink consistent LBT failure is not triggered in the resource pool to a total quantity of RB sets in the resource pool is not less than Q %). If there is no such resource pool, it is considered to select/reselect/switch a resource pool of the normal resource pool type having less than PRB sets on which the sidelink consistent LBT failure is not triggered in the resource pool (or a proportion of a quantity of RB sets on which the sidelink consistent LBT failure is not triggered in the resource pool to a total quantity of RB sets in the resource pool is less than Q %). If neither of these two types of resource pools exists (in this case, it may be determined that a special event occurs), then it is considered to use the special resource pool type.

Case 3: Determine the respective priorities of the candidate resources of the second resource granularity based on sidelink configuration information, where the sidelink configuration information includes a priority of each candidate resource of the second resource granularity configured for the terminal.

In this embodiment, the terminal may receive a sidelink configuration from the network side device, and the sidelink configuration includes a priority of each resource (namely, the candidate resource) that the terminal may use. Based on the priority of each candidate resource, the terminal preferentially selects a candidate resource with a high priority as a target resource pool.

For example, for a Radio Resource Control CONNECTED (RRC_CONNECTED) terminal, the network side device configures a priority for a resource pool corresponding to each resource pool ID, and the UE may determine the priority of the resource pool corresponding to each resource pool ID based on this. For a Radio Resource Control IDLE (RRC_IDLE)/inactive (INACTIVE) terminal, the network side device may broadcast a priority of each sidelink transmission resource pool through a system message, and the UE may determine the priority of each transmission resource pool based on this.

### Implementation 4

This implementation describes an example in which the first resource is recovered from the sidelink consistent LBT failure, and the sidelink consistent LBT failure triggered on the first resource is canceled. That the first resource is recovered from the sidelink consistent LBT failure indicates at least one of the following:
the first resource on which the sidelink consistent LBT failure is triggered becomes an available resource of the terminal again, and in this case, the terminal may continue to use the first resource for SL transmission; and
the terminal is allowed to continue to use the first resource for SideLink (SL) transmission, for example, the network side device allows the terminal to continue to use the first resource for SL transmission. The SL transmission may include at least one of the following: a PSSCH; a PSCCH; a PSBCH; a PSFCH; and a Sidelink Synchronization Signal Block (S-SSB).

During specific implementation, if the terminal determines that the first resource is recovered from the sidelink consistent LBT failure, the terminal determines that at least one resource or all resources of a third resource granularity in the first resource are recovered from the sidelink consistent LBT failure; and if the terminal cancels the sidelink consistent LBT failure triggered on the first resource, the terminal cancels the sidelink consistent LBT failure triggered on at least one resource or all resources of a third resource granularity in the first resource, where first resource is a first resource of the first resource granularity, and the first resource granularity is greater than the third resource granularity.

It should be noted that main resource granularities involved in SL transmission are sorted from large to small as follows: carrier (or cell)>BWP>resource pool>RB set>sub-channel. The first resource granularity described in the embodiments of this application may be any resource granularity in the order, the second resource granularity may be a resource granularity greater than the first resource granularity in the order, and the third resource granularity may be a resource granularity less than the first resource granularity in the order.

An example in which the first resource granularity is a resource pool level, and the third resource granularity is an RB set level is used. That the third resource granularity is smaller than the first resource granularity indicates that one resource pool may include at least one RB set.

When the UE determines that the resource pool is recovered from the sidelink consistent LBT failure or cancels the sidelink consistent LBT failure triggered on the resource pool, the UE determines that at least one RB set or all RB sets in the resource pool are recovered from the sidelink consistent LBT failure or cancels the SL consistent LBT failure triggered on at least one RB set or all RB sets in the resource pool.

As an implementation, when it is determined that the first resource is recovered from the sidelink consistent LBT failure, the terminal may cancel the sidelink consistent LBT failure triggered on the first resource, so that the terminal can perform resource selection or resource reselection or resource switching, to perform SL transmission on the first resource.

It should be noted that the terminal may determine that the first resource is recovered from the sidelink consistent LBT failure, or cancel the sidelink consistent LBT failure triggered on the first resource in the following three manners.

Manner 1: Recover/cancel based on a timer.

In this embodiment, after a T1 time from a moment at which the terminal triggers the sidelink consistent LBT failure on the first resource, an occupancy of the first resource is likely to decrease. In this case, the terminal may determine that the first resource is recovered from the sidelink consistent LBT failure, or cancel the sidelink consistent LBT failure triggered on the first resource. The T1 time is determined by at least one of the following: a fixed time length T2; a time length T3 corresponding to a CAPC value; and a random time length T5 within a maximum back-off time length T4.

Values of the time parameter T2, T3, and T4 may be configured by a network, predefined by a protocol, or determined through negotiation between UEs; and the CAPC value meets at least one of the following conditions:
each different CAPC value corresponds to a different time length T3;
the CAPC value is a highest or lowest CAPC value corresponding to to-be-transmitted data in a buffer of the terminal;
the CAPC value is a CAPC value corresponding to a to-be-sent Transport Block (TB)/a to-be-sent signal, and the to-be-sent signal is an S-SSB or a PSFCH; and
the CAPC value is a highest or lowest CAPC value corresponding to a plurality of to-be-sent TBs/a plurality of to-be-sent signals, and the to-be-sent signal is an S-SSB or a PSFCH.

Manner 2: Recover/cancel based on successful SL transmission.

Because the S-SSB and the PSFCH are high-priority signals for the SL system, when the UE triggers the sidelink consistent LBT failure, the UE may still be allowed to try sending the S-SSB or the PSFCH by using the resource on which the sidelink consistent LBT failure is triggered. Similarly, the resource on which the sidelink consistent LBT failure is triggered may also be allowed to continue to send the PSSCH or the PSCCH.

Therefore, for Manner 2, it may be determined that the first resource is recovered from the sidelink consistent LBT failure, or the sidelink consistent LBT failure triggered on the first resource may be canceled in the following two cases in which the SL transmission is successful.

Case 1: If the terminal successfully sends a first sidelink signal by using the first resource on which the sidelink consistent LBT failure is triggered, the terminal determines that the first resource is recovered from the sidelink consistent LBT failure, or cancels the sidelink consistent LBT failure triggered on the first resource.

The first sidelink signal includes at least one of the following: a PSSCH; a PSCCH; a PSBCH; a PSFCH; and an S-SSB.

Case 2: If the terminal successfully sends a first sidelink signal for N times by using the first resource on which the sidelink consistent LBT failure is triggered, the terminal determines that the first resource is recovered from the sidelink consistent LBT failure, or cancels the sidelink consistent LBT failure triggered on the first resource.

The first sidelink signal may include at least one of the following: a PSSCH; a PSCCH; a PSBCH; a PSFCH; and an S-SSB. The parameter N may be configured by a network, predefined by a protocol, or determined through negotiation between UEs.

Manner 3: Recover/cancel based on measurement.

In this embodiment, the terminal may determine that the first resource is recovered from the sidelink consistent LBT failure, or cancel the sidelink consistent LBT failure triggered on the first resource based on at least one of the following conditions:
in response to a case in which the terminal measures that a CO value of a carrier in which the sidelink consistent LBT failure is triggered on an RB set is less than or equal to a first threshold (Thresh1), determining that the carrier is recovered from the sidelink consistent LBT failure, or canceling the sidelink consistent LBT failure triggered on the carrier;
in response to a case in which the terminal measures that a CBR value of a resource pool in which the sidelink consistent LBT failure is triggered on an RB set is less than or equal to a second threshold (Thresh2), determining that the resource pool is recovered from the sidelink consistent LBT failure, or canceling the sidelink consistent LBT failure triggered on the resource pool; and
in response to a case in which the terminal measures that an RB set channel occupancy of an RB set on which the sidelink consistent LBT failure is triggered is less than or equal to a third threshold (Thresh3), determining that the RB set is recovered from the sidelink consistent LBT failure, or canceling the sidelink consistent LBT failure triggered on the RB set, where the RB set channel occupancy is used for measuring a channel occupancy in the RB set.

In some implementations, the RB set channel occupancy is: a proportion of a quantity of sub-channels/slots (slot)/Orthogonal Frequency Division Multiplexing symbol (OFDM symbol) with a SideLink Received Signal Strength Indication (SL-RSSI) value or an average SL-RSSI value exceeding a fourth threshold (Thresh4) to a total quantity of sub-channels/slots/OFDM symbols in the RB set within a time length T6; or
the RB set channel occupancy is: a proportion of a quantity of sub-channels/slots/OFDM symbols with an RSSI value or an average RSSI value exceeding a fifth threshold (Thresh5) to a total quantity of sub-channels/slots/OFDM symbols in the RB set within a time length T7.

The thresholds Thresh1 to 5 and the time length parameters T6 and T7 are configured by a network, predefined by a protocol, or determined through negotiation between UEs.

### Implementation 5

This implementation describes an example of determining a CAPC value of a non-standardized PC5 5th generation QoS Identifier (PQI).

Before the terminal determines that the sidelink consistent LBT failure is triggered on the first resource, in a case that QoS Flow of a sidelink service that the terminal needs to send corresponds to a non-standardized PQI, the terminal determines a CAPC value referenced for performing an LBT operation, and the terminal performs the LBT operation.

It can be understood that the UE needs to perform the LBT operation to count triggering times of the sidelink LBT failure before determining occurrence of the sidelink consistent LBT failure. When QoS Flow of the sidelink service that the terminal needs to send corresponds to a non-standardized PQI, the UE needs to determine a CAPC value referenced for performing the LBT.

If a CAPC value is configured for the non-standardized PQI in network-configured or pre-configured information, or a CAPC value is configured for each bearer in the network-configured or pre-configured information, the UE uses the configured CAPC value to determine a CAPC value of a current non-standardized PQI.

If the CAPC value of the non-standardized PQI required to perform the current LBT operation is not configured in the network-configured or pre-configured information, the UE needs to determine the currently required CAPC value of the non-standardized PQI by itself by using a mapping table between a CAPC value and a standard PQI and non-standardized PQI information of the CAPC value configured in the network-configured or pre-configured information. In this case, the UE may compare a Packet Delay Budget (PDB) value in a QoS parameter of the non-standardized PQI required to perform the current LBT operation with a PDB value of the standard PQI or a PDB value of the non-standardized PQI configured with the CAPC value in the network-configured or pre-configured information, to find a standard PQI or a non-standardized PQI with a closest PDB value (such as an upper limit value or a lower limit value with a closest PDB value) as a matched standard PQI or non-standardized PQI (namely, the CAPC value referenced for performing the LBT).

In an embodiment, it is considered that the UE may still find a plurality of matched standard PQIs or non-standardized PQIs in the foregoing manners, resulting in that results are not unique. Therefore, the determining, by the terminal, a CAPC value referenced for performing an LBT operation may include at least one of the following.

A-1: In response to a case in which CAPC values that are corresponding to a plurality of matched standard PQIs or non-standardized PQIs and that are determined by the terminal are all first CAPC values, determining that the CAPC value referenced for performing the LBT operation is the first CAPC value.

In this embodiment, if the determined CAPC values corresponding to the plurality of matched standard PQIs or non-standardized PQIs are all the same (for example, are all CAPC-1), it may be determined that the CAPC value referenced for performing the LBT operation is CAPC-1.

A-2: The terminal determines, based on whether the sidelink service that needs to be sent is a Mission Critical Service (MCS), the CAPC value referenced for performing the LBT operation from the determined CAPC values corresponding to the plurality of matched standard PQIs or non-standardized PQIs.

It can be understood that the matched standard PQI may be determined by using PDB values of standard PQIs in the mapping table (a mapping relationship between a CAPC value and a standard PQI is recorded) and the target PDB value of the non-standardized PQI corresponding to QoS Flow of the sidelink service that the terminal needs to send. The matched non-standardized PQI may be determined by using the PDB value of the non-standardized PQI configured with the CAPC value in the network-configured or pre-configured information, and the target PDB value. For example, a plurality of non-standardized PQIs and standard PQIs with PDB values closest to the PDB value (namely, the target PDB value) of the non-standardized PQI required to perform the current LBT operation are used as the plurality of matched standard PQIs or non-standardized PQIs.

The method for processing a sidelink consistent listen before talk failure provided in this embodiment of this application may be executed by an apparatus for processing a sidelink consistent listen before talk failure. In this embodiment of this application, an example in which the apparatus for processing a sidelink consistent listen before talk failure performs the method for processing a sidelink consistent listen before talk failure is used to describe the apparatus for processing a sidelink consistent listen before talk failure provided in this embodiment of this application.

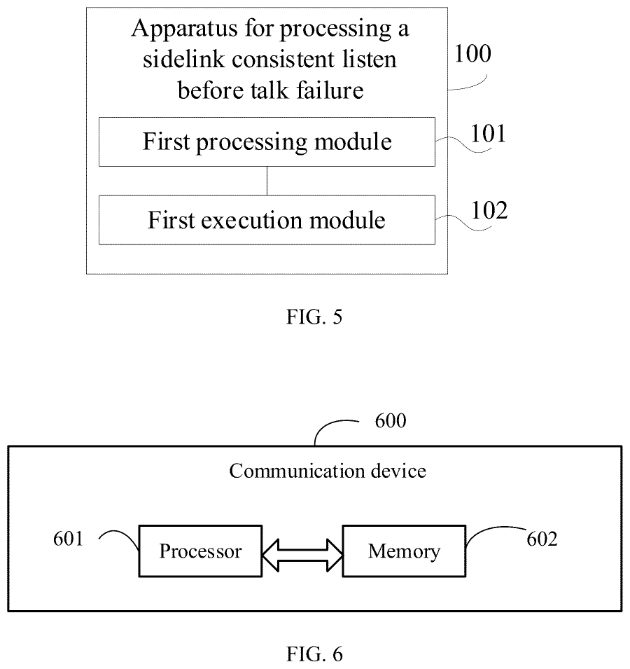

According to a second aspect, an embodiment of this application provides an apparatus for processing a sidelink consistent listen before talk failure, and the apparatus may be applied to a terminal. As shown in FIG. 5, the apparatus 100 for processing a sidelink consistent listen before talk failure includes:
a first processing module 101, configured to determine that the sidelink consistent LBT failure is triggered on a first resource; and
a first execution module 102, configured to perform a first operation, where the first operation includes at least one of the following:
resource selection or resource reselection or resource switching;
determining that the first resource is recovered from the sidelink consistent LBT failure, or canceling the sidelink consistent LBT failure triggered on the first resource; and
a MAC layer of the terminal informs a PHY layer: the first resource is recovered from the sidelink consistent LBT failure, or canceling the sidelink consistent LBT failure triggered on the first resource.

In some implementations, the first resource is a first resource of the first resource granularity; the first operation is resource selection or resource reselection or resource switching; and the first execution module 102 includes:
a first execution submodule, configured to perform resource selection or resource reselection or resource switching at a second resource granularity, where the second resource granularity is greater than the first resource granularity.

In some implementations, the first execution submodule includes a second execution module, and the second execution module is configured to perform at least one of the following:
in a case that the first resource is a first RB set, performing resource pool (resource pool) selection/reselection/switching;
in a case that the first resource is a first sub-channel, performing RB set selection/reselection/switching;
in a case that the first resource is a first resource pool, performing BWP selection/reselection/switching; and
in a case that the first resource is a first BWP, performing carrier selection/reselection/switching.

In some implementations, the first resource is a first resource of the first resource granularity; the first operation is resource selection or resource reselection or resource switching; and the first execution module 102 performs resource selection or resource reselection or resource switching in a case that a second resource of the second resource granularity to which the first resource belongs meets at least one of the following conditions:
there are at least M resources that are of the first resource granularity and on which the sidelink consistent LBT failure is triggered and is not canceled yet in the second resource, and M is a value not less than 0;
a proportion of resources that are of the first resource granularity and on which the sidelink consistent LBT failure is triggered and is not canceled yet in the second resource is not less than N %, and N is a value that is not less than 0 and not greater than 100; and
the sidelink consistent LBT failure is triggered and is not canceled yet on all resources of the first resource granularity in the second resource.

In some implementations, the first resource is a first resource of the first resource granularity; the first operation is resource selection or resource reselection or resource switching; and a target resource of the second resource granularity selected/reselected/switched by the terminal in performing the first operation meets at least one of the following conditions:
there are at least P resources that are of the first resource granularity and on which the sidelink consistent LBT failure is not triggered in the target resource of the second resource granularity, and P is a value not less than 0;
a proportion of resources that are of the first resource granularity and on which the sidelink consistent LBT failure is not triggered in the target resource of the second resource granularity is not less than Q %, and Q is a value that is not less than 0 and not greater than 100; and
there is at least one resource that is of the first resource granularity and on which the sidelink consistent LBT failure is not triggered in the target resource of the second resource granularity.

In some implementations, the first resource is a first resource of the first resource granularity; the first operation is resource selection or resource reselection or resource switching; and the first execution module 102 includes:
a fourth execution submodule, configured to determine respective priorities of candidate resources of the second resource granularity; and
a fifth execution submodule, configured to select/reselect/switch the target resource of the second resource granularity based on the respective priorities of the candidate resources of the second resource granularity.

In some implementations, the fourth execution submodule determines the respective priorities of the candidate resources of the second resource granularity based on at least one of the following:
respective types of the candidate resources of the second resource granularity;
a quantity or a proportion of resources that are of the first resource granularity and on which the sidelink consistent LBT failure is not triggered in each candidate resource of the second resource granularity; and
sidelink configuration information, where the sidelink configuration information includes a priority of each candidate resource of the second resource granularity configured for the terminal.

In some implementations, in a case that the second resource granularity is a resource pool, types of candidate resource pools include at least one of the following:
a normal resource pool type; and
a special resource pool type, where
a priority of the normal resource pool type is higher than a priority of the special resource pool type, and the normal resource pool type includes at least one of the following:
a discovery resource pool; and
a communication resource pool.

In some implementations, the priorities of the candidate resources of the second resource granularity successively decrease in the following order:
the quantity or the proportion of the resources that are of the first resource granularity and on which the sidelink consistent LBT failure is not triggered in the candidate resource of the second resource granularity is not less than a first threshold;
the quantity or the proportion of the resources that are of the first resource granularity and on which the sidelink consistent LBT failure is not triggered in the candidate resource of the second resource granularity is less than the first threshold; and
the type of the candidate resource of the second resource granularity is a target type.

In some implementations, that the first resource is recovered from the sidelink consistent LBT failure indicates at least one of the following:
the first resource on which the sidelink consistent LBT failure is triggered becomes an available resource of the terminal again; and
the terminal is allowed to continue to use the first resource for sidelink (SL) transmission, and the SL transmission includes at least one of the following: a PSSCH; a PSCCH; a PSBCH; a PSFCH; and an S-SSB.

In some implementations, when it is determined that the first resource is recovered from the sidelink consistent LBT failure, the apparatus further includes:
a second execution module, configured to cancel the sidelink consistent LBT failure triggered on the first resource.

In some implementations, the first resource is a first resource of a first resource granularity; and in response to a case in which the first execution module 102 determines that the sidelink consistent listen before talk (LBT) failure is triggered on at least one resource or all resources of a third resource granularity in the first resource, the first execution module 102 determines that the sidelink consistent listen before talk (LBT) failure is triggered on the first resource, and the first resource granularity is greater than the third resource granularity.

In some implementations, the first resource is a first resource of a first resource granularity; and in response to a case in which the first execution module 102 determines that the first resource is recovered from the sidelink consistent LBT failure, or cancels the sidelink consistent LBT failure triggered on the first resource, the first execution module 102 determines that at least one resource or all resources of a third resource granularity in the first resource are recovered from the sidelink consistent LBT failure, or cancels the sidelink consistent LBT failure triggered on at least one resource or all resources of a third resource granularity in the first resource, and the first resource granularity is greater than the third resource granularity.

In some implementations, the first execution module 102 includes:
a sixth execution submodule, configured to: determine, after a T1 time from a moment at which the sidelink consistent LBT failure is triggered on the first resource, that the first resource is recovered from the sidelink consistent LBT failure, or cancel the sidelink consistent LBT failure triggered on the first resource, where the T1 time is determined by at least one of the following:
a fixed time length T2;
a time length T3 corresponding to a CAPC value; and
a random time length T5 within a maximum back-off time length T4.

In some implementations, the CAPC value meets at least one of the following conditions:
each different CAPC value corresponds to a different time length T3;
the CAPC value is a highest or lowest CAPC value corresponding to to-be-transmitted data in a buffer of the terminal;
the CAPC value is a CAPC value corresponding to a to-be-sent TB/a to-be-sent signal, and the to-be-sent signal is an S-SSB or a PSFCH; and
the CAPC value is a highest or lowest CAPC value corresponding to a plurality of to-be-sent TBs/a plurality of to-be-sent signals, and the to-be-sent signal is an S-SSB or a PSFCH.

In some implementations, the first execution module 102 includes:
a seventh execution submodule, configured to: in response to a case in which the terminal successfully sends a first sidelink signal by using the first resource on which the sidelink consistent LBT failure is triggered, determine that the first resource is recovered from the sidelink consistent LBT failure, or cancel the sidelink consistent LBT failure triggered on the first resource, where
the first sidelink signal includes at least one of the following: a PSSCH; a PSCCH; a PSBCH; a PSFCH; and an S-SSB.

In some implementations, the first execution module 102 includes:
an eighth execution submodule, configured to: in response to a case in which the terminal successfully sends a first sidelink signal for N times by using the first resource on which the sidelink consistent LBT failure is triggered, determine that the first resource is recovered from the sidelink consistent LBT failure, or cancel the sidelink consistent LBT failure triggered on the first resource, where
the first sidelink signal includes at least one of the following: a PSSCH; a PSCCH; a PSBCH; a PSFCH; and an S-SSB.

In some implementations, the first execution module 102 includes:
a ninth execution submodule, configured to: in response to a case in which the terminal measures that a CO value of a carrier on which the sidelink consistent LBT failure is triggered on an RB set is less than or equal to a first threshold (Thresh1), determine that the carrier is recovered from the sidelink consistent LBT failure, or cancel the sidelink consistent LBT failure triggered on the carrier; or
a tenth execution submodule, configured to: in response to a case in which the terminal measures that a CBR value of a resource pool in which the sidelink consistent LBT failure is triggered on an RB set is less than or equal to a second threshold (Thresh2), determine that the resource pool is recovered from the sidelink consistent LBT failure, or cancel the sidelink consistent LBT failure triggered on the resource pool; or
an eleventh execution submodule, configured to: in response to a case in which the terminal measures that an RB set channel occupancy of an RB set on which the sidelink consistent LBT failure is triggered is less than or equal to a third threshold (Thresh3), determine that the RB set is recovered from the sidelink consistent LBT failure, or cancel the sidelink consistent LBT failure triggered on the RB set, where the RB set channel occupancy is used for measuring a channel occupancy in the RB set.

In some implementations, the RB set channel occupancy is: a proportion of a quantity of sub-channels/slots/OFDM symbols with an SL-RSSI value or an average SL-RSSI value exceeding a fourth threshold (Thresh4) to a total quantity of sub-channels/slots/OFDM symbols in the RB set within a time length T6; or
the RB set channel occupancy is: a proportion of a quantity of sub-channels/slots/OFDM symbols with an RSSI value or an average RSSI value exceeding a fifth threshold (Thresh5) to a total quantity of sub-channels/slots/OFDM symbols in the RB set within a time length T7.

In some implementations, the apparatus further includes:
a second processing module, configured to: before determining that the sidelink consistent LBT failure is triggered on the first resource, in a case that QoS Flow of a sidelink service that the terminal needs to send corresponds to a non-standardized PQI, determine a CAPC value referenced for performing an LBT operation; and
a third execution module, configured to perform the LBT operation.

In some implementations, the determining, by the terminal, a CAPC value referenced for performing an LBT operation includes at least one of the following:
in response to a case in which CAPC values that are corresponding to a plurality of matched standard PQIs or non-standardized PQIs and that are determined by the terminal are all first CAPC values, determining that the CAPC value referenced for performing the LBT operation is the first CAPC value; and
determining, by the terminal based on whether the sidelink service that needs to be sent is a mission critical service, the CAPC value referenced for performing the LBT operation from the determined CAPC values corresponding to the plurality of matched standard PQIs or non-standardized PQIs.

In some implementations, the apparatus further includes:
a third processing module, configured to: before determining the CAPC value referenced for performing the LBT operation, determine a matched standard PQI based on a Packet Delay Budget (PDB) value of the standard PQI and a target PDB value of the non-standardized PQI corresponding to QoS Flow of the sidelink service that the terminal needs to send; or before determining the CAPC value referenced for performing the LBT operation, determine a matched non-standardized PQI based on a PDB value of the non-standardized PQI configured with the CAPC value in network-configured or pre-configured information and the target PDB value.

The apparatus for processing a sidelink consistent listen before talk failure provided in this embodiment of this application can implement the processes implemented in the embodiment of the method for processing a sidelink consistent listen before talk failure according to the first aspect, and a same technical effect is achieved. To avoid repetition, details are not described herein again.

The apparatus for processing a sidelink consistent listen before talk failure in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the terminal 11, and the another device may be a server, a Network Attached Storage (NAS), or the like. This is not specifically limited in this embodiment of this application.

As shown in FIG. 6, an embodiment of this application further provides a communication device 600, including a processor 601 and a memory 602, and the memory 602 stores a program or an instruction that can be run on the processor 601. For example, in a case that the communication device 600 is a terminal, the program or the instruction is executed by the processor 601 to implement the steps of the embodiment of the method for processing a sidelink consistent listen before talk failure, and a same technical effect can be achieved. To avoid repetition, details are not described herein again.

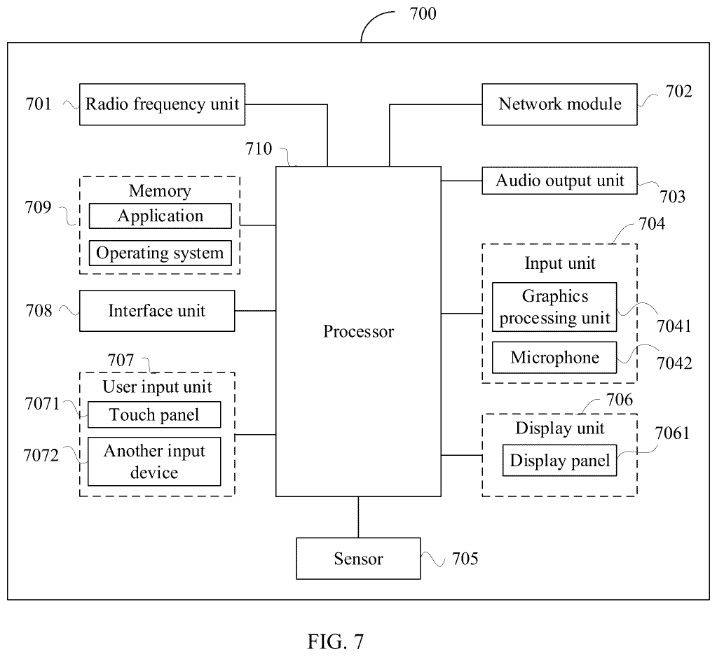

An embodiment of this application further provides a terminal, including a processor and a communication interface, the communication interface is coupled to the processor, and the processor is configured to run a program or an instruction to implement the steps in the embodiment of the method for processing a sidelink consistent listen before talk failure according to the first aspect. The terminal embodiment is corresponding to the method embodiment on the terminal side, each implementation process and implementation of the method embodiment can be applied to the terminal embodiment, and a same technical effect can be achieved. Specifically, FIG. 7 is a schematic diagram of a hardware structure of a terminal according to an embodiment of this application.

The terminal 700 includes but is not limited to at least a part of components such as a radio frequency unit 701, a network module 702, an audio output unit 703, an input unit 704, a sensor 705, a display unit 706, a user input unit 707, an interface unit 708, a memory 709, and a processor 710.

It may be understood by a person skilled in the art that the terminal 700 may further include a power supply (such as a battery) that supplies power to each component. The power supply may be logically connected to the processor 710 by using a power management system, to implement functions such as charging, discharging, and power consumption management by using the power management system. The terminal structure shown in FIG. 7 constitutes no limitation on the terminal, and the terminal may include more or fewer components than those shown in the figure, or combine some components, or have different component arrangements. Details are not described herein.

It should be understood that in this embodiment of this application, the input unit 704 may include a Graphics Processing Unit (GPU) 7041 and a microphone 7042. The graphics processing unit 7041 processes image data of a static picture or a video obtained by an image capture apparatus (for example, a camera) in a video capture mode or an image capture mode. The display unit 706 may include a display panel 7061, and the display panel 7061 may be configured in a form of a liquid crystal display, an organic light-emitting diode, or the like. The user input unit 707 includes at least one of a touch panel 7071 and another input device 7072. The touch panel 7071 is also referred to as a touchscreen. The touch panel 7071 may include two parts: a touch detection apparatus and a touch controller. The another input device 7072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 701 may transmit the downlink data to the processor 710 for processing. In addition, the radio frequency unit 701 may send uplink data to the network side device. Generally, the radio frequency unit 701 includes but is not limited to an antenna, an amplifier, a transceiver, a coupler, a low noise amplifier, a duplexer, and the like.

The memory 709 may be configured to store a software program or an instruction and various data. The memory 709 may mainly include a first storage area for storing a program or an instruction and a second storage area for storing data. The first storage area may store an operating system, and an application or an instruction required by at least one function (for example, a sound playing function or an image playing function). In addition, the memory 709 may include a volatile memory or a non-volatile memory. The nonvolatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch Link DRAM (SLDRAM), and a Direct Rambus RAM (DRRAM). The memory 709 in this embodiment of this application includes but is not limited to these memories and any memory of another proper type.

The processor 710 may include one or more processing units. In some implementations, an application processor and a modem processor are integrated into the processor 710. The application processor mainly processes an operating system, a user interface, an application, or the like. The modem processor mainly processes a wireless communication signal, for example, a baseband processor. It may be understood that, the modem processor may not be integrated into the processor 710.

An embodiment of this application further provides a readable storage medium, and the readable storage medium stores a program or an instruction. When the program or the instruction is executed by a processor, the processes of the embodiment of the method for processing a sidelink consistent listen before talk failure are implemented, and a same technical effect can be achieved. To avoid repetition, details are not described herein again.

The processor is a processor in the terminal in the foregoing embodiments. The readable storage medium includes a computer-readable storage medium, such as a computer ROM, a RAM, a magnetic disk, or an optical disc. In some examples, the readable storage medium may be a non-transient readable storage medium.

An embodiment of this application further provides a chip, the chip includes a processor and a communication interface, and the communication interface is coupled to the processor. The processor is configured to run a program or an instruction, to implement the processes of the embodiment of the method for processing a sidelink consistent listen before talk failure, and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product. The computer program/program product is stored in a storage medium, the computer program/program product is executed by at least one processor to implement the processes of the embodiment of the method for processing a sidelink consistent listen before talk failure, and a same technical effect can be achieved. To avoid repetition, details are not described herein again.

It should be noted that, in this specification, the term “include,” “comprise,” or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in the implementations of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by a computer software product and a required universal hardware platform, or certainly may be implemented by using hardware. The computer software product is stored in a storage medium (for example, a ROM, a RAM, a magnetic disk, or a compact disc), and includes a plurality of instructions for instructing a terminal or a network side device to perform the method described in the embodiments of this application.

The embodiments of this application are described above with reference to the accompanying drawings, but this application is not limited to the above specific implementations, and the above specific implementations are only illustrative and not restrictive. Under the enlightenment of this application, those of ordinary skill in the art can make many forms of implementations without departing from the purpose of this application and the protection scope of the claims, all of which fall within the protection of this application.

1. A method for processing a sidelink consistent Listen Before Talk (LBT) failure, performed by a terminal, wherein the method comprises:
determining that the sidelink consistent LBT failure is triggered on a first resource; and
performing a first operation, wherein the first operation comprises at least one of the following:
resource selection, resource reselection, or resource switching;
determining that the first resource is recovered from the sidelink consistent LBT failure, or canceling the sidelink consistent LBT failure triggered on the first resource; or
a Media Access Control (MAC) layer of the terminal informs a PHYsical (PHY) layer the following: the first resource is recovered from the sidelink consistent LBT failure, or canceling the sidelink consistent LBT failure triggered on the first resource.

2. The method according to claim 1, wherein the first resource is a resource of a first resource granularity; the first operation is resource selection, resource reselection, or resource switching; and the performing resource selection, resource reselection, or resource switching comprises:
performing resource selection, resource reselection, or resource switching at a second resource granularity, wherein the second resource granularity is greater than the first resource granularity.

3. The method according to claim 2, wherein the performing resource selection, resource reselection, or resource switching at a second resource granularity comprises at least one of the following:
when the first resource is a first Resource Block set (RB set), performing resource pool selection, resource pool reselection, or resource pool switching;
when the first resource is a first sub-channel, performing RB set selection, RB set reselection, or RB set switching;
when the first resource is a first resource pool, performing BandWidth Part (BWP) selection, BWP reselection, or BWP switching; or
when the first resource is a first BWP, performing carrier selection, carrier reselection, or carrier switching.

4. The method according to claim 1, wherein:
the first resource is a resource of a first resource granularity;
the first operation is resource selection, resource reselection, or resource switching; and
the terminal performs resource selection, resource reselection, or resource switching when a second resource of a second resource granularity, to which the first resource belongs, meets at least one of the following conditions:
there are at least M resources of the first resource granularity on which the sidelink consistent LBT failure is triggered and not yet canceled in the second resource, and M is a value not less than 0;
a proportion of resources of the first resource granularity on which the sidelink consistent LBT failure is triggered and not yet canceled in the second resource is not less than N %, and N is a value not less than 0 and not greater than 100; or
the sidelink consistent LBT failure is triggered and not yet canceled on all resources of the first resource granularity in the second resource.

5. The method according to claim 1, wherein:
the first resource is a resource of a first resource granularity;
the first operation is resource selection, resource reselection, or resource switching; and
a target resource of the second resource granularity being selected, reselected, or switched by the terminal in performing the first operation meets at least one of the following conditions:
there are at least P resources of the first resource granularity on which the sidelink consistent LBT failure is not triggered in the target resource of the second resource granularity, and P is a value not less than 0;
a proportion of resources of the first resource granularity on which the sidelink consistent LBT failure is not triggered in the target resource of the second resource granularity is not less than Q %, and Q is a value not less than 0 and not greater than 100; or
there is at least one resource of the first resource granularity on which the sidelink consistent LBT failure is not triggered in the target resource of the second resource granularity.

6. The method according to claim 1, wherein:
the first resource is a resource of a first resource granularity;
the first operation is resource selection, resource reselection, or resource switching; and
the performing a first operation comprises:
determining respective priorities of candidate resources of the second resource granularity based on at least one of the following:
respective types of the candidate resources of the second resource granularity;
a quantity or a proportion of resources of the first resource granularity on which the sidelink consistent LBT failure is not triggered in each candidate resource of the second resource granularity; or
sidelink configuration information, wherein the sidelink configuration information comprises a priority of each candidate resource of the second resource granularity configured for the terminal; and
selecting, reselecting, or switching the target resource of the second resource granularity based on the respective priorities of the candidate resources of the second resource granularity.

7. The method according to claim 6, wherein when the second resource granularity is a resource pool, types of candidate resource pools comprise at least one of the following:
a normal resource pool type; or
a special resource pool type, wherein
a priority of the normal resource pool type is higher than a priority of the special resource pool type, and the normal resource pool type comprises at least one of the following:
a discovery resource pool; or
a communication resource pool.

8. The method according to claim 6, wherein the priorities of the candidate resources of the second resource granularity successively decrease in the following order:
the quantity or the proportion of the resources of the first resource granularity on which the sidelink consistent LBT failure is not triggered in the candidate resource of the second resource granularity is not less than a first threshold;
the quantity or the proportion of the resources of the first resource granularity on which the sidelink consistent LBT failure is not triggered in the candidate resource of the second resource granularity is less than the first threshold; and
the type of the candidate resource of the second resource granularity is a target type.

9. The method according to claim 1, wherein that the first resource is recovered from the sidelink consistent LBT failure indicates at least one of the following:
the first resource on which the sidelink consistent LBT failure is triggered becomes an available resource of the terminal again; or
the terminal is allowed to continue to use the first resource for SideLink (SL) transmission, and the SL transmission comprises at least one of the following:
a Physical Sidelink Shared CHannel (PSSCH);
a Physical Sidelink Control CHannel (PSCCH);
a Physical Sidelink Broadcast CHannel (PSBCH);
a Physical Sidelink Feedback CHannel (PSFCH); or
a Sidelink Synchronization Signal Block (S-SSB).

10. The method according to claim 1, wherein when it is determined that the first resource is recovered from the sidelink consistent LBT failure, the method further comprises:
canceling the sidelink consistent LBT failure triggered on the first resource.

11. The method according to claim 1, wherein the first resource is a resource of a first resource granularity; and wherein
when the terminal determines that the sidelink consistent LBT failure is triggered on at least one resource or all resources of a third resource granularity in the first resource, the terminal determines that the sidelink consistent LBT failure is triggered on the first resource, and the first resource granularity is greater than the third resource granularity.

12. The method according to claim 1, wherein the first resource is a resource of a first resource granularity; and wherein
when the terminal determines that the first resource is recovered from the sidelink consistent LBT failure, or cancels the sidelink consistent LBT failure triggered on the first resource, the terminal determines that at least one resource or all resources of a third resource granularity in the first resource are recovered from the sidelink consistent LBT failure, or cancels the sidelink consistent LBT failure triggered on at least one resource or all resources of a third resource granularity in the first resource, and the first resource granularity is greater than the third resource granularity.

13. The method according to claim 1, wherein the determining that the first resource is recovered from the sidelink consistent LBT failure, or canceling the sidelink consistent LBT failure triggered on the first resource comprises:
determining, after a T1 time from a moment at which the sidelink consistent LBT failure is triggered on the first resource, that the first resource is recovered from the sidelink consistent LBT failure, or canceling the sidelink consistent LBT failure triggered on the first resource, wherein the T1 time is determined by at least one of the following:
a fixed time length T2;
a time length T3 corresponding to a Channel Access Priority Class (CAPC) value; or
a random time length T5 within a maximum back-off time length T4.

14. The method according to claim 13, wherein the CAPC value meets at least one of the following conditions:
each different CAPC value corresponds to a different time length T3;
the CAPC value is a highest or lowest CAPC value corresponding to to-be-transmitted data in a buffer of the terminal;
the CAPC value is a CAPC value corresponding to a to-be-sent Transport Block (TB) or a to-be-sent signal, and the to-be-sent signal is a Sidelink Synchronization Signal Block (S-SSB) or a Physical Sidelink Feedback CHannel (PSFCH); and
the CAPC value is a highest or lowest CAPC value corresponding to a plurality of to-be-sent TBs or a plurality of to-be-sent signals, and the to-be-sent signal is the S-SSB or the PSFCH.

15. The method according to claim 1, wherein the determining that the first resource is recovered from the sidelink consistent LBT failure, or canceling the sidelink consistent LBT failure triggered on the first resource comprises:
when the terminal successfully sends a first sidelink signal by using the first resource on which the sidelink consistent LBT failure is triggered, determining that the first resource is recovered from the sidelink consistent LBT failure, or canceling the sidelink consistent LBT failure triggered on the first resource, wherein
the first sidelink signal comprises at least one of the following:
a Physical Sidelink Shared CHannel (PSSCH);
a Physical Sidelink Control CHannel (PSCCH);
a Physical Sidelink Broadcast CHannel (PSBCH);
a Physical Sidelink Feedback CHannel (PSFCH); or
a Sidelink Synchronization Signal Block (S-SSB).

16. The method according to claim 1, wherein the determining that the first resource is recovered from the sidelink consistent LBT failure, or canceling the sidelink consistent LBT failure triggered on the first resource comprises:
when the terminal successfully sends a first sidelink signal for N times by using the first resource on which the sidelink consistent LBT failure is triggered, determining that the first resource is recovered from the sidelink consistent LBT failure, or canceling the sidelink consistent LBT failure triggered on the first resource, wherein
the first sidelink signal comprises at least one of the following:
a Physical Sidelink Shared CHannel (PSSCH);
a Physical Sidelink Control CHannel (PSCCH);
a Physical Sidelink Broadcast CHannel (PSBCH);
a Physical Sidelink Feedback CHannel (PSFCH); or
a Sidelink Synchronization Signal Block (S-SSB).

17. The method according to claim 1, wherein the determining that the first resource is recovered from the sidelink consistent LBT failure, or canceling the sidelink consistent LBT failure triggered on the first resource comprises:
when the terminal measures that a Channel Occupancy (CO) value of a carrier in which the sidelink consistent LBT failure is triggered on an Resource Block set (RB set) is less than or equal to a first threshold (Thresh1), determining that the carrier is recovered from the sidelink consistent LBT failure, or canceling the sidelink consistent LBT failure triggered on the carrier; or
when the terminal measures that a Constant Bit Rate (CBR) value of a resource pool in which the sidelink consistent LBT failure is triggered on the RB set is less than or equal to a second threshold (Thresh2), determining that the resource pool is recovered from the sidelink consistent LBT failure, or canceling the sidelink consistent LBT failure triggered on the resource pool; or
when the terminal measures that an RB set CO of the RB set on which the sidelink consistent LBT failure is triggered is less than or equal to a third threshold (Thresh3), determining that the RB set is recovered from the sidelink consistent LBT failure, or canceling the sidelink consistent LBT failure triggered on the RB set, wherein the RB set CO is used for measuring a CO in the RB set,
wherein the RB set CO is: a proportion of a quantity of sub-channels, slots, or Orthogonal Frequency Division Multiplexing symbols (OFDM symbols) with a SideLink Received Signal Strength Indication (SL-RSSI) value or an average SL-RSSI value exceeding a fourth threshold (Thresh4) to a total quantity of sub-channels, slots, or OFDM symbols in the RB set within a time length T6; or
the RB set CO is: a proportion of a quantity of sub-channels, slots, or OFDM symbols with an RSSI value or an average RSSI value exceeding a fifth threshold (Thresh5) to a total quantity of sub-channels, slots, or OFDM symbols in the RB set within a time length T7.

18. The method according to claim 1, wherein before the determining that the sidelink consistent LBT failure is triggered on a first resource, the method further comprises:
when Quality of Service (QoS) Flow of a sidelink service that the terminal needs to send corresponds to a non-standardized PC5 5th generation QoS Identifier (PQI), determining a Channel Access Priority Class (CAPC) value referenced for performing an LBT operation; and
performing the LBT operation,
wherein the determining a CAPC value referenced for performing an LBT operation comprises at least one of the following:
when CAPC values that are corresponding to a plurality of matched standard PQIs or non-standardized PQIs and that are determined by the terminal are all first CAPC values, determining that the CAPC value referenced for performing the LBT operation is the first CAPC value; or
determining, based on whether the sidelink service that needs to be sent is a mission critical service, the CAPC value referenced for performing the LBT operation from the determined CAPC values corresponding to the plurality of matched standard PQIs or non-standardized PQIs.

19. The method according to claim 18, wherein before the determining a CAPC value referenced for performing an LBT operation, the method further comprises:
determining a matched standard PQI based on a Packet Delay Budget (PDB) value of the standard PQI and a target PDB value of the non-standardized PQI corresponding to QoS Flow of the sidelink service that the terminal needs to send; or
determining a matched non-standardized PQI based on a PDB value of the non-standardized PQI configured with the CAPC value in network-configured or pre-configured information and the target PDB value.

20. A terminal, comprising:
a memory storing computer-readable instructions; and
a processor coupled to the memory and configured to execute the computer-readable instructions, wherein the computer-readable instructions, when executed by the processor, cause the processor to perform a method comprising:
determining that the sidelink consistent LBT failure is triggered on a first resource; and
performing a first operation, wherein the first operation comprises at least one of the following:
resource selection, resource reselection, or resource switching;
determining that the first resource is recovered from the sidelink consistent LBT failure, or canceling the sidelink consistent Listen Before Talk (LBT) failure triggered on the first resource; or
a Media Access Control (MAC) layer of the terminal informs a PHYsical (PHY) layer the following: the first resource is recovered from the sidelink consistent LBT failure, or canceling the sidelink consistent LBT failure triggered on the first resource.
